(19) United States
(12) Patent Application Publication
(10) Pub. No.: US 2007/0222764 A1
(43) Pub. Date: Sep. 27, 2007

(54) Glide touch sensor based interface for navigation infotainment systems

(75) Inventor: David Wang, Belmont, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Centrality Communications, Inc.

(21) Appl. No.: 11/387,473

(22) Filed: Mar. 22, 2006

(51) Int. Cl. G06F 3/041

(52) U.S. Cl. 345/173

(57) ABSTRACT

The invention provides glide touch sensor interfaces for controlling various features of a navigation infotainment system, which combines navigation guidance capabilities with multimedia features. In an embodiment, the navigation infotainment system includes a glide touch sensor that may be used to control navigation features of the system such as zoom level, map panning, point of interest scrolling, volume control, and brightness and contrast control. In addition, the glide touch sensor may be used to control multimedia features of the system including sound volume and play-list scrolling.

### FIELD OF THE INVENTION

The present invention relates generally to navigational infotainment systems, and more particularly, to human interfaces for navigation infotainment systems.

### BACKGROUND OF THE INVENTION

With the development of radio and space technologies, several satellites based navigation systems have already been built and more will be in use in the near future. One example of such satellites based navigation systems is Global Positioning System (GPS), which is built and operated by the United States Department of Defense. The system uses twenty-four or more satellites orbiting the earth at an altitude of about 11,000 miles with a period of about twelve hours. These satellites are placed in six different orbits such that at any time a minimum of six satellites are visible at any location on the surface of the earth except in the polar region. Each satellite transmits a time and position signal referenced to an atomic clock. A typical GPS receiver locks on to this signal and extracts the data contained in it. Using signals from a sufficient number of satellites, a GPS receiver can calculate its position, velocity, altitude, and time. The Russian built GLONASS and the European Union proposed Galileo are the two other important satellite based navigation systems.

A typical GPS or other navigation signal receiver is interfaced to maps of the region of interest. This region of interest map is displayed by the receiver with the position derived by the navigation receiver indicated by a suitable marker. This indicated position may be changing due to the motion of the vehicle in which it is placed. In this case, an arrow may represent the vehicle or GPS receiver in motion with the direction of the arrow representing the direction of the motion. Some of the features of this device like the zoom-in or zoom-out of the map, brightness and contrast of the map display, scrolling the points of interest list around the present position or at another given position and the volume of voice prompts, etc., are usually controlled by some type of mechanical switches. But present day receivers are using touch sensor based switches in place of mechanical switches. These touch sensor based switches or interface devices have longer life, easy to operate, does not involve mechanical parts which require maintenance. Various touch sense technology implementation methods are given below.

Touch Sensor Technology

Many physical principles have been exploited in the development of touch sensors. In most cases, the developments in touch sensing technologies are application driven. It should be recognized that the operation of a touch sensor is very dependant on the material of the object being gripped.

Resistive Based Sensors

The use of compliant materials that have a defined force-resistance characteristics have received considerable attention in touch and tactile sensor research. The basic principle of this type of sensor is the measurement of the resistance of a conductive elastomer or foam between two points. The majority of the sensors use an elastomer that consists of a carbon doped rubber.

In the above sensor the resistance of the elastomer changes with the application of force, resulting from the deformation of the elastomer altering the particle density.

If the resistance measurement is taken between opposing surfaces of the elastomer, the upper contacts have to be made using a flexible printed circuit to allow movement under the applied force. Measurement from one side can easily be achieved by using a dot-and-ring arrangement on the substrate. Resistive sensors have also been developed using elastomer cords laid in a grid pattern, with the resistance measurements being taken at the points of intersection. Arrays with 256-elements have been constructed.

The conductive elastomer or foam based sensor, while relatively simple does suffer from a number of significant disadvantages:
An elastomer has a long nonlinear time constant. In addition the time constant of the elastomer, when force is applied, is different from the time constant when the applied force is removed.
The force-resistance characteristic of elastomer based sensors are highly nonlinear, requiring the use of signal processing algorithms.
Due to the cyclic application of forces experienced by a touch sensor, the resistive medium within the elastomer will migrate over a period of time. Additionally, the elastomer will become permanently deformed and fatigue leading to permanent deformation of the sensor. This will give the sensor a poor long-term stability and will require replacement after an extended period of use.

Even with the electrical and mechanical disadvantages of conductive elastomers and foams, the majority of industrial analogue touch sensors that have been based on the principle of resistive sensing. This is due to the simplicity of their design.

Force Sensing Resistor

A force sensing resistor is a piezoresistivity conductive polymer, which changes resistance in a predictable manner following application of force to its surface. It is normally supplied as a polymer sheet which has had the sensing film applied by screen printing. The sensing film consists of both electrically conducting and non-conducting particles suspended in matrix. The particle sizes are of the order of fraction of microns, and are formulated to reduce the temperature dependence, improve mechanical properties and increase surface durability. Applying a force to the surface of the sensing film causes particles to touch the conducting electrodes, changing the resistance of the film. As with all resistive based sensors the force sensitive resistor requires a relatively simple interface and can operate satisfactorily in moderately hostile environments.

Capacitive Based Sensors

These sensors are based on the variation of capacitance between two plates when finger is brought near these plates. The capacitance between two parallel plates is given by:

$$C = \frac{ɛA}{d}$$

where A is the plate area, d the distance between the plates, and e the permittivity of the dielectric medium. A capacitive touch sensor relies on the applied force either changing the distance between the plates or the effective surface area of the capacitor. In such a sensor the two conductive plates of the sensor are separated by a dielectric medium, which is also used as the elastomer to give the sensor its force-to-capacitance characteristics.

To maximize the change in capacitance as force is applied, it is preferable to use a high permittivity, dielectric in a coaxial capacitor design. In this type of sensor, as the size is reduced to increase the spatial resolution, the sensor's absolute capacitance will decrease. With the limitations imposed by the sensitivity of the measurement techniques, and the increasing domination of stray capacitance, there is an effective limit on the resolution of a capacitive array. The use of a highly dielectric polymer such as polyvinylidene fluoride maximizes the change capacitance. From an application viewpoint, the coaxial design is better as its capacitance will give a greater increase for an applied force than the parallel plate design.

To measure the change in capacitance, a number of techniques can be, the most popular is based on the use of a precision current source. A second approach is to use the sensor as part of a tuned or L.C. circuit, and measure the frequency response. Significant problem with capacitive sensors can be caused if they are in close proximity with the end effector's, this leads to stray capacitance. This can be minimized by good circuit layout and mechanical design of the touch sensor.

Magnetic Based Sensor

There are two approaches to the design of touch or tactile sensors based on magnetic transduction. Firstly, the movement of a small magnet by an applied force will cause the flux density at the point of measurement to change. The flux measurement can be made by either a Hall effect or a magnetoresistive device. Second, the core of the transformer or inductor can be manufactured from a magnetoelastic material that will deform under pressure and cause the magnetic coupling between transformer windings, or a coil's inductance to change. A magnetoresistive or magnetoelastic material is a material whose magnetic characteristics are modified when the material is subjected to changes in externally applied physical forces. The magnetorestrictive or magnetoelastic sensor has a number of advantages that include high sensitivity and dynamic range, no measurable mechanical hysteresis, a linear response, and physical robustness.

If a very small permanent magnet is held above the detection device by a complaint medium, the change in flux caused by the magnet's movement due to an applied force can be detected and measured. The field intensity follows an inverse relationship, leading to a nonlinear response, which can be easily linearized by processing. A one-dimensional sensor where a row of twenty hall effect devices placed opposite a magnet has been constructed. A tactile sensor using magnetoelastic material has been developed, where the material was bonded to a substrate, and then used as a core for an inductor. As the core is stressed, the material's susceptibility changed, which is measured as a change in the coil's inductance.

Optical Sensors

The rapid expansion of optical technology in recent years has led to the development of a wide range of touch sensors. The operating principles of optical-based sensors are well known and fall into two classes:
Intrinsic, where the optical phase, intensity, or polarization of transmitted light are modulated without interrupting the optical path.
Extrinsic, where the physical stimulus interacts with the light external to the primary light path.

Intrinsic and extrinsic optical sensors can be used for touch, torque, and force sensing. For industrial applications, the most suitable will be that which requires the least optical processing. For example the detection of phase shift, using interferometry, is not considered a practical option for touch and force sensors. For touch and force-sensing applications, the extrinsic sensor based on intensity measurement is the most widely used due to its simplicity of construction and the subsequent information processing. The potential benefits of using optical sensors can be summarized as follow:

Immunity to external electromagnetic interference, which is widespread in many applications.
Intrinsically safe.
The use of optical fiber allows the sensor to be located some distance from the optical source and receiver.
Low weight and volume.

Touch optical sensors have been developed using a range of optical technologies:

Optical Fiber Based Sensors

In the previous section, optical fibers where used are solely for the transmission of light to and from the sensor, however touch sensors can be constructed from the fiber itself. A number of touch sensors have been developed using this approach. In the majority of cases either the sensor structure was too big to be attached or the operation was too complex for use in the industrial environment. A suitable design can be based on internal-state microbending of optical fibers. Microbending is the process of light attenuation in the core of fiber when a mechanical bend or perturbation (of the order of few microns) is applied to the outer surface of the fiber. The degree of attenuation depends on the fiber parameter's as well as radius of curvature and spatial wavelength of the bend. Research has demonstrated the feasibility of effecting microbending on an optical fiber by the application of a force to a second orthogonal optical fiber.

Piezoelectric Sensors

Polymeric materials that exhibit piezoelectric properties are suitable for use as a touch sensors, while quartz and some ceramics have piezoelectric properties, polymers such as polyvinylidene fluoride (PVDF) are normally used in sensors.

Polyvinylidene fluoride is not piezoelectric in its raw state, but can be made piezoelectric by heating the PVDF within an electric field. Polyvinylidene fluoride is supplied sheets between as 5 microns and 2 mm thick, and has good mechanical properties. A thin layer of metalization is applied to both sides of the sheet to collect the charge and permit electrical connections being made. In addition it can be moulded, hence PVDF has number of attraction when considering touch sensor material as an artificial skin.

Strain Gauges in Touch Sensors

A strain gauge when attached to a surface will detect the change in length of the material as it is subjected to external forces. The strain gauge is manufactured from either resistive elements (foil, wire, or resistive ink) or from semiconducting material. A typical resistive gauge consists of the resistive grid being bonded to an epoxy backing film. If the strain gauge is pre-stressed prior to the application of the backing medium, it is possible to measure both tensile and compressive stresses. The semi-conducting strain gauge is fabricated from a suitable doped piece of silicon, in this case the mechanism used for the resistance change is the piezoresistive effect.

Silicon Based Sensors

Technologies for micromachining sensors are currently being developed world-wide. The developments can be directly linked to the advanced processing capabilities of the integrated circuit industry, that has developed fabrication techniques that allow the interfacing of the non-electronic environment to be integrated through micro-electromechanical systems. Though not as dimensionally rigorous as the more mature silicon planer technology, micromachining is inherently more complex as it is involves the manufacture of a three-dimensional object. Therefore the fabrication relies on additive layer techniques to produce the mechanical structure.

The excellent characteristics of silicon, that has made micromachined sensors possible, include a tensile strength comparable to steel, elastic to breaking point, and there is very little mechanical hysteresis in devices made from as single crystal, a low thermal coefficient of expansion.

To date it is apparent that microengineering has been applied most successfully to sensors. Some sensor applications take advantage of the device-to-device or batch-to-batch repeatability of wafer-scale processing to remove expensive calibration procedures. Current applications are restricted largely to pressure and acceleration sensors, though these in principle can be used as force sensors. As the structure is very delicate, there still are problems in developing a suitable touch sensor for industrial applications.

Surface Acoustic Wave Devices

This touch sensitive touch panel is based on acoustic wave propagation over a glass substrate. This technology is inexpensive but requires a specialized sensor with etching and attached transducers and complicated and expensive electronics. Further, it operates on the principle that the user's finger acoustically dampens the propagating signal, which produces an unpredictable touch measurement. Today, touch sensors are mainly used as touch pads in lap top computers to move the arrow in the screen and for scrolling. Thus, lap top computers use two-dimensional touch pads. The other use of touch sensors is in touch screens found in many handheld devices like PALM where the display screen itself is used as a touch sensor. Finger or stylus pens are used to tap on the object to be activated. A number of US patents describe various techniques of implementation. Some of the U.S. patents include U.S. Pat. Nos. 3,921,166, 4,103,252, 4,455,452, 4,680,430, 5,543,590, 5,650,597, 6,961,049, and published U.S. Patent Applications including 20060015826, 20050073507.

These touch sensors are finding use in electronic devices like the one used in a typical in-vehicle environment. Most of these devices include CD, DVD, MP3, satellite radio receiver, etc. with associated knobs and switches to control features such as volume control, Play-list scrolling, etc.

These controllers require the driver's attention and energy for proper operation. In addition, these controllers are slow and require more time to operate. Regular maintenance is also required for these mechanical switches. As a result, touch sensor switches are being increasingly used in place of the above controllers. But these touch sensor switches require frequent tapping with fingers to change the associated feature values by a large amount. Published U.S. Patent Application 20060015826 discloses a multi-touch sensor for hard disk multimedia players. However, this sensor only allows a small length of scrolling in discrete steps and requires a combination of touch gestures involving more than one finger at a time. Toshiba Corp. also uses a type of continuous sliding touch in some models of its multimedia players. U.S. Pat. No. 6,879,930 assigned to Microsoft Corporation describes a capacitance touch slider. Cypress Semiconductor Incorporated is one of the manufacturers of the sliding touch sensors known widely as CapSense devices. A glide touch (GLIDETOUCH®) sensor has been patented and used by cirque/ALPS Electric company (Alpine America a subsidy of ALPS) for multimedia players. The IPOD® also uses a slider for scrolling the song list. This slider has many advantages like fast operation, less driver attention, etc. However, to date this has not been used in navigation receivers.

### SUMMARY

The system described herein provides glide touch sensor interfaces for controlling various features of a navigation infotainment system, which combines navigation guidance capabilities with multimedia features. In an embodiment, the navigation infotainment system includes a glide touch sensor that may be used to control navigation features of the system such as zoom level, map panning, point of interest scrolling, volume control, and brightness and contrast control. In addition, the glide touch sensor may be used to control multimedia features of the system including sound volume and play-list scrolling.

### BRIEF DESCRIPTION OF THE DRAWINGS

FIG. 1 shows a schematic of a navigation infotainment system with a glide touch sensor interface according to an embodiment.

FIG. 2 shows a navigation infotainment system with a glide touch sensor according to an embodiment.

FIG. 3 shows a navigation infotainment system with a glide touch sensor installed in a vehicle dashboard according to an embodiment.

FIG. 4 shows an example of a map displayed on a navigation infotainment system with a glide touch sensor according to an embodiment.

FIG. 5 shows a navigation infotainment system with two glide touch sensors according to an embodiment.

FIG. 6 shows an example of a scroll window on a navigation infotainment system with a glide touch sensor according to an embodiment.

### DETAILED DESCRIPTION OF THE PREFERRED EMBODIMENTS

The system described herein provides glide touch sensor interfaces for controlling the navigation and multimedia features of a navigation infotainment system. The infotainment system includes a navigation receiver, e.g., GPS receiver, for providing the infotainment system with navigation guidance capabilities, and a multimedia player capable of playing MPEG, MP3, CD, DVD and/or a host of other multimedia files. The infotainment system may also include a digital or analog radio system, a digital or analog television system, wireless Internet receiver, and/or other communications device. A navigation infotainment system as defined herein is a system that includes a multimedia player and a navigation receiver all operating as a single system. Further, the multimedia play and navigation receiver share resources of the navigation infotainment system as required.

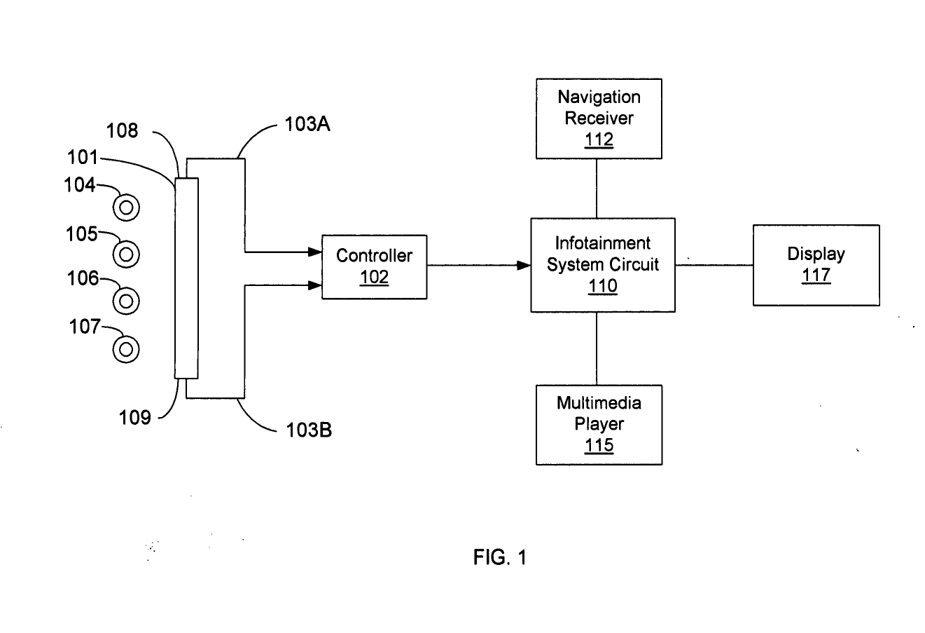

FIG. 1 shows a navigation infotainment system with a glide touch sensor interface according to an embodiment. The infotainment system includes a navigation receiver 112, e.g., GPS receiver, for providing the infotainment system with navigation guidance capabilities, a multimedia player 115, and a display 117, e.g., LCD screen. The infotainment system also includes an infotainment system circuit 110 connected to the navigation receiver 112, the multimedia player 115, and the display 117 for controlling the navigational and multimedia operations of the infotainment system.

The glide touch interface includes a glide touch sensor 101 and an associated controller 102. Resistive and capacitive types of sliding sensors may be used for the glide touch 101. The interface also includes buttons 104-107 for selecting different features of the infotainment system to be controlled by the glide touch sensor 102. For example, the buttons 104-107 may be used to select different display features, e.g., brightness or contrast, audio features, e.g., volume, or navigation features, e.g., zoom, of the infotainment system to be controlled by the glide touch sensor 101. Although four buttons are shown in FIG. 1, any number of buttons may be used. For example, more buttons may be used to select additional features. The buttons may be used with the multimedia player 115 of the infotainment system for, e.g., volume control or scrolling through a play list of multimedia files. There is no need to exclusively indicate whether the buttons apply to navigational or multimedia operations as it is understood from the context.

To control the selected feature using the glide touch sensor 101, a user may glide a finger on the glide touch sensor 101. The glide touch sensor 101 sends a signal representing the position of the finger on the glide touch sensor 101 to a controller 102 through connecting wires 103A and 103B. In response, the controller 102 generates and sends a control signal to the infotainment system circuit 110, which controls the value of the selected feature based on the position of the finger on the glide touch 101. The infotainment system circuit 110 may be connected to the buttons 104-107 via wires (not shown), and select the feature to be controlled based on which of the buttons is pressed 104-107.

In an embodiment, the controller 102 controls the value of the selected feature in proportion to the position of the finger on the glide touch 101 starting from edge 108 towards the other edge 109. In this embodiment, the edge 108 may represent a minimum value and the edge 109 may represent a maximum value. Positions on the glide touch 101 between the edges 108 and 109 may represent intermediate values in proportion to their distances from the edges 108 and 109. Further, the value of the feature may be gradually increased by sliding the finger from the edge 108 towards the edge 109. It is also possible for the edge 108 to represent a maximum value and the edge 109 to represent a minimum value, and to gradually increase the value by sliding the finger from the edge 109 towards the edge 108. In addition, the values may continue to scroll up or down by holding down the finger on the top or bottom of the glide touch 101.

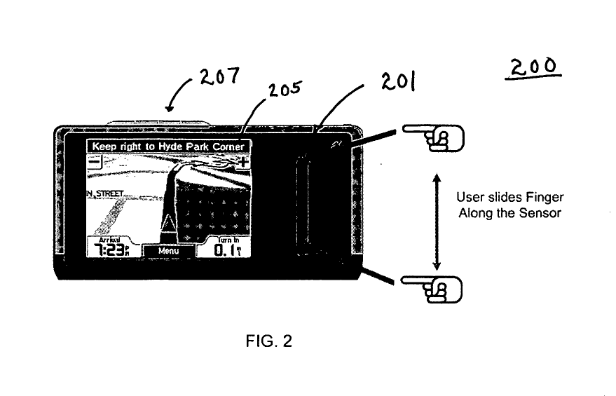

FIG. 2 shows an example of an infotainment system 200 with a glide touch interface according to an embodiment of the invention. The infotainment system includes a display 205 and a glide touch sensor 201 for controlling various navigation and multimedia features of the infotainment system. The infotainment system also includes buttons 207 for selecting features to be controlled by the glide touch 201. The buttons 207 need not be arranged as shown in FIG. 2 and can be placed anywhere near the glide touch 201, above the display 205, below the display 205 or on the other side of the display 205. Further, the buttons need not be present in all embodiments. A display menu may be substituted for the buttons, as discussed below. FIG. 2 shows an example of the infotainment system 200 providing driving directions on the display 205 in a navigation mode.

An infotainment system 300 according to an embodiment may be installed in the dashboard 315 of a vehicle as shown in FIG. 3 for providing onboard infotainment. The infotainment system 300 include a glide touch 301 for controlling various navigation and multimedia features of the infotainment system 300. The infotainment system may be mounted on the dashboard instead of integrated into the dashboard.

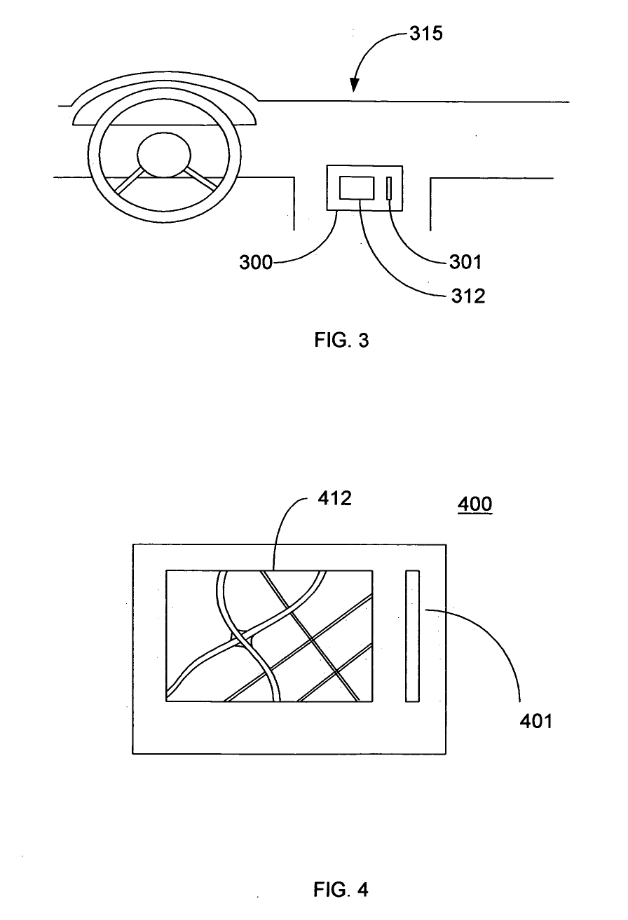

In a navigation mode, an important feature that can be controlled by the glide touch is the zoom level of a displayed map. The zoom feature may be selected by pressing one of the buttons 104-107 shown in FIG. 1. FIG. 4 shows an example in which a map 412 is displayed on an infotainment system 400 and the zoom feature is selected. The map 412 may be a street, an aerial map, or the like. To zoom in, the user may slide a finger on the glide touch 401 in the direction from top to bottom, and stop when a desired zoom level has been attained. To zoom out, the user may slide a finger on the glide touch 401 in the direction from bottom to top and stop when a desired zoom level has been attained. In the later case, one of the buttons 104-107 may be pressed to select the zoom feature, if the zoom feature is not already selected. Further, the displayed map may include an indicator showing the current zoom level of the map, e.g., a mark on a zoom scale.

The zoom feature may also be selected from a menu list on the display. For example, a menu list may list various navigation features, including the zoom feature. The user may select the zoom feature from the menu list by sliding a finger on the glide touch to move, e.g., a highlighter, to the zoom feature. Once the zoom feature is highlighted, the user may tap on the glide touch once or multiple times to select the zoom feature. Alternatively, once the zoom feature is highlighted, the user may press a button to select the zoom feature.

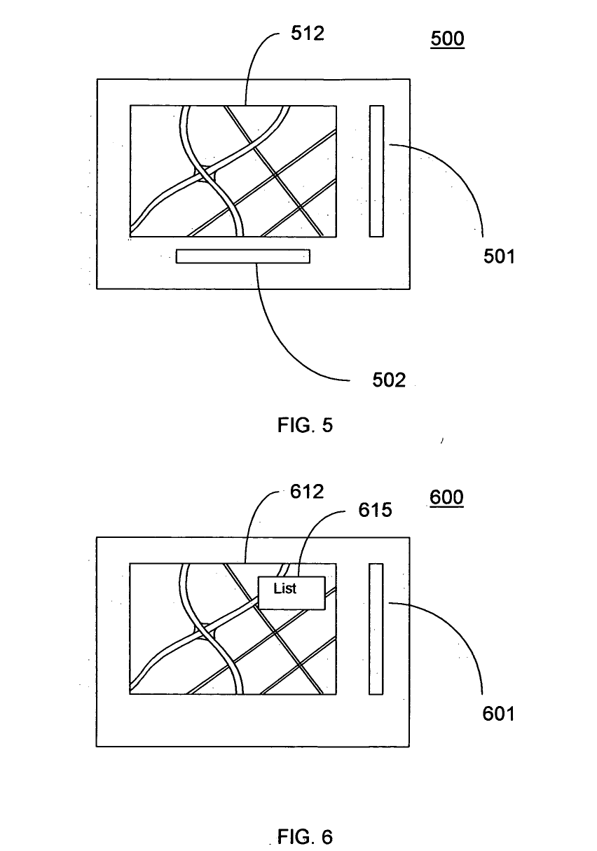

The glide touch may also be used to pan the displayed map up or down or pan the displayed map left or right. As in the case of zooming, the pan feature may be selected by pressing one of the buttons 104-107. The user may slide a finger on the glide touch in the direction from top to bottom to pan up, i.e., display a portion of the map that was hidden before. To provide panning in both an up/down and left/right direction, the infotainment system may include two glide touch sensors. FIG. 5 shows an example of an infotainment system 500 with a glide touch 501 placed in a vertical direction and a glide touch placed 502 in a horizontal direction. The vertical glide touch 501 may be used to pan in the up/down direction and the horizontal glide touch 502 may be used to pan in the left/right direction. Further, the map may be further panned by holding the finger at the top or bottom (left or right).

In addition to zooming and panning, the glide touch may be used for adjusting the contrast and/or brightness of the map display.

It may be important to view a list of the visible satellites with their associated signal-to-noise ratios and satellite health. The maximum number of satellites visible from the GPS constellation is 11 satellites and an inclusion of satellites from other navigation systems like Galileo and GLONASS will require a larger list. A list of visible satellites may be viewed in a small window (so that it does not block a considerable map display area) that shows a portion of the list at a time. Any one of the visible satellites in the list may be viewed by scrolling the list in the window using a glide touch. The top edge of the glide touch may correspond to the satellite with the highest signal-to-noise ratio. The user may slide a finger on the glide touch towards the bottom edge to display the other satellites in decreasing order of their signal-to-noise ratios. The bottom edge of the glide touch may correspond to the satellite with the lowest signal-to-noise ratio. In addition to the signal-to-noise ratios, the health of the visible satellites may also be viewed together with the signal-to-noise ratios. If the health of a satellite is poor, this may explain why the position accuracy is not good under limited acquired satellite condition.

The quality of a pseudorange measurement depends on how the acquired satellites are placed with respect to each other. Acquired satellites placed near each other result in a less accurate position estimation. On the other hand, acquired satellites placed far apart from each other give a good position estimation. This spread of satellites is measured by what is known as GDOP (Geometric Dilution Of Precision). A list of GDOP values measured over a time interval may help in identifying the precise position by finding the position with the best GDOP. In an embodiment, the device stores a list of the GDOP values measured over an interval of time. The list of GDOP values may then be viewed in a window by scrolling the list using the glide touch. The top edge of the glide touch may correspond to the latest GDOP value and the bottom edge of the glide touch may correspond to the oldest GDOP values. The user may slide a finger on the glide touch towards the bottom edge to display the GDOP values in order of increasing age. The position and time of each GDOP value may also be displayed next to the associated GDOP value.

Some GPS receivers have integrated temperature sensors used to correct frequency drift due to temperature variation. Temperature values measured by a temperature sensor may be stored in memory over a time interval. A list of the stored temperature values may be viewed by scrolling the list in a window using the glide touch. The top edge of the glide touch may correspond to the latest temperature value and the bottom edge of the glide touch may correspond to the oldest temperature value. The user may slide a finger on the glide touch towards the bottom edge to display the temperature values in order of increasing age. The time of each temperature value may also be displayed next to the associated temperature value.

The ephemeris and almanac of the navigation satellites are used to determine the position of the satellites with ephemeris being more precise than almanac. The most recent ephemeris or almanac is helpful in providing a precise estimation of the position of a satellite for computing the pseudorange between the satellite and the device which may help in reducing satellite acquisition time. It is possible to view the satellite ephemeris or almanac and compare these values with the latest values available through an Internet or wireless means. A list of satellites and associated ephemeris or almanac may be viewed by scrolling the list in a window using the glide touch. The top edge of the glide touch may correspond to the highest powered satellite while the bottom to that of the lowest powered satellite. Various parameters of the ephemeris or almanac may be viewed one after the other.

FIG. 6 shows an example of an infotainment system 600 according to an embodiment, in which the glide touch 601 can be used for point of interest scrolling in a window 615. In this embodiment, the window 615 is small so that it does not block a considerable map display area 612. The user may use the glide touch to scroll a list in the window 615 by sliding a finger on the glide touch 601. Further, the user may scroll to the top of the list by holding the finger down on the top of the glide touch 601. The window 615 according to this embodiment may be used to view any one of the lists of the previous embodiments described above. Alternatively, the window 615 may be larger and/or occupy a considerable area of the display. Further, the user may switch the window 615 between a small size and a large size, e.g., by pressing a button.

Further, lists of other points of interest may be scrolled in the window 615 using the glide touch 601. For example, the lists may include a list of restaurants, shops, or gas stations within a given area. In anther example, the lists may include a list of restaurants, shops or gas stations within a certain distance from the user's current position, as measured by the navigation receiver of the infotainment system. In this example, the restaurant, shops, or gas stations may be listed in order of increasing distance with the closest restaurant, shop, or gas station at the top of the list.

The glide touch sensor may be used to adjust other features. For example, the glide touch may be used to adjust the volume of the infotainment system when operating in a navigation mode or a multimedia mode. First, a button may be pressed to select volume. The user may then slide a finger on the glide touch in the direction from top to bottom to gradually increase the volume and stop when a desired volume has been attained. The glide touch may also be to scroll television or radio channels or scroll a multimedia play-list in the multimedia mode.

Although the present invention has been described in terms of the presently preferred embodiments, it is to be understood that the disclosure is not to be interpreted as limiting. Various alterations and modifications will no doubt become apparent to those skilled in the art after having read this disclosure. Accordingly, it is intended that the appended claims be interpreted as covering all alterations and modifications as fall within the spirit and scope of the invention.

1. A method for using a glide touch sensor in a navigation infotainment system, the navigation infotainment system including a navigation receiver and any combination of a multimedia player, a radio receiver or a television receiver, comprising:
using the glide touch sensor to control features of the navigation infotainment system.

2. The method of claim 1, further comprising using the glide touch sensor to zoom a map displayed on the infotainment system.

3. The method of claim 1, further comprising using the glide touch sensor to pan a map displayed on the infotainment system.

4. The method of claim 1, further comprising using the glide touch sensor for point-of-interest scrolling.

5. The method of claim 1, further comprising using the glide touch sensor to control volume.

6. The method of claim 1, further comprising using the glide touch sensor to control brightness of a map displayed on the infotainment system.

7. The method of claim 1, further comprising using the glide touch sensor to control contrast of a map displayed on the infotainment system.

8. The method of claim 1, further comprising using the glide touch sensor to scroll through a list of acquired satellites with associated signal-to-noise ratios and health of the satellites.

9. The method of claim 1, further comprising using the glide touch sensor to scroll through stored quality measurements over a period of time.

10. The method of claim 1, further comprising using the glide touch sensor to scroll through stored temperature measurements over a period of time.

11. The method of claim 1, further comprising using the glide touch sensor to scroll through acquired satellite ephemeris and almanac data.

12. The method of claim 1, further comprising using the glide touch sensor to scroll through a multimedia play list.

13. The method of claim 1, further comprising using the glide touch sensor to scroll through radio channels.

14. The method of claim 1, further comprising using the glide touch sensor to scroll through television channels.

15. The method of claim 1, further comprising pressing a button to select which feature is to be controlled by the glide touch.

16. The method of claim 1, wherein the navigation infotainment system comprises two or more glide touch sensors.

17. The method of claim 1, further comprising using the glide touch sensor for selecting which feature is to be controlled by the glide touch.

18. The method of claim 1, further comprising using the glide touch sensor for browsing a menu hierarchy.

19. A navigation infotainment system, comprising:
a system circuit;
a navigation receiver coupled to the system circuit;
a multimedia player, radio receiver, television receiver or any combination thereof coupled to the system circuit; and
a glide touch sensor coupled to the system circuit, wherein the system circuit controls navigation and multimedia features of the infotainment system based on inputs from the glide touch sensor.

20. The system of claim 19, further comprising means for selecting which one of the features is controlled by the glide touch.

21. The system of claim 20, wherein the selecting means comprises a plurality of buttons.

22. The system of claim 20, wherein the selecting means comprises a menu list of features displayed on the infotainment system and the glide touch is capable of selecting features from the menu list.

23. The system of claim 19, wherein the glide touch is capable of zooming a map displayed on the infotainment system

24. The system of claim 19, wherein the glide touch sensor is capable of panning a map displayed on the infotainment system.

25. The system of claim 19, wherein the glide touch sensor is capable of point-of-interest scrolling.

26. The system of claim 19, wherein the glide touch is capable of control volume.

27. The system of claim 19, wherein the glide touch sensor is capable of controlling brightness of a map displayed on the infotainment system.

28. The system of claim 19, wherein the glide touch sensor is capable of controlling contrast of a map displayed on the infotainment system.

29. The system of claim 19, wherein the glide touch sensor is capable of scrolling through a list of acquired satellites with associated signal-to-noise ratios and health of the satellites.

30. The system of claim 19, wherein the glide touch sensor is capable of scrolling through stored quality measurements over a period of time.

31. The system of claim 19, wherein the glide touch sensor is capable of scrolling through stored temperature measurements over a period of time.

32. The system of claim 19, wherein the glide touch sensor is capable of scrolling through acquired satellite ephemeris and almanac data.

33. The system of claim 19, wherein the glide touch sensor is capable of scrolling through a multimedia play list.

34. The system of claim 19, wherein the glide touch sensor is capable of scrolling through radio channels.

35. The system of claim 19, wherein the glide touch sensor is capable of scrolling through television channels.

36. The system of claim 19, further comprising two or more glide touch sensors.

37. The system of claim 19, wherein the glide touch sensor is capable of browsing a menu hierarchy.
